(19) United States
(12) Patent Application Publication
(10) Pub. No.: US 2005/0151748 A1
(43) Pub. Date: Jul. 14, 2005

(54) Dynamic memory managing device and method thereof

(75) Inventor: Sung-hee Cho, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/022,891

(22) Filed: Dec. 28, 2004

(30) Foreign Application Priority Data
Jan. 8, 2004 (KR) 10-2004-0001193

(51) Int. Cl. G09G 5/36

(52) U.S. Cl. 345/548

(57) ABSTRACT

A dynamic managing device and method thereof in which a memory for storing the off-screen data is automatically determined by means of an operation value obtained after performing a predetermined operation using a variable including a weight corresponding to each memory included in the off-screen data, thereby avoiding the need for a user to personally determine which memory should be used for storing the off-screen data and, thus, improving the convenience to the user. The off-screen data can be transferred to other memories by means of a variable value included in the off-screen data after the off-screen data are stored in a predetermined memory. Therefore, it is possible to improve performance of a system.

### CROSS-REFERENCE TO RELATED APPLICATION

This application claims priority from Korean Patent Application No. 10-2004-0001193 filed on Jan. 8, 2004 in the Korean Intellectual Property Office, the disclosure of which is incorporated herein by reference in its entirety.

### BACKGROUND OF THE INVENTION

1. Field of the Invention

The present invention relates to a dynamic memory managing device and a method thereof, and more particularly to a dynamic memory managing device and a method thereof, which can automatically determine a memory for storing off-screen data by means of a predetermined variable value included in the off-screen data.

2. Description of the Prior Art

Generally, a computer or a system embedded in a personal digital assistant (PDA), a cellular phone, a set-top box, etc., includes a central processing unit, a main memory, a secondary memory, an input unit, an output unit, etc.

As the demand for various multimedia functions increases, such a computer or such an embedded system has been developed such that the output unit processes a large amount of data.

As for a video controller for processing off-screen data displayed on the output unit, performance of the video controller is dependent on a graphic engine and a video memory.

The video memory is included in the video controller and transfers data to a frame buffer of the video controller at a high speed.

Accordingly, it is advantageous that off-screen data to be outputted to the output unit are stored in the video memory in view of improvement of performance of the video controller.

A conventional memory managing device includes a device driver 10 for performing functions for storing off-screen data made by a user and for outputting the off-screen data to the output unit, a main memory 20 and a video memory 30 for storing the off-screen data according to a determination of a storage memory by the device driver 10, and a display part 40 for outputting the off-screen data as shown in FIG. 1.

Herein, according to a process for outputting off-screen data stored in the main memory 20 to the display part 40, the off-screen data are transferred to the video memory 30, and then, outputted to the display part 40 under the control of the deice driver 10.

At this time, the user includes information about a memory for storing the off-screen data in the off-screen data in advance when making the off-screen data.

Accordingly, the device driver 10 checks information about a storage memory included in the off-screen data so as to store the off-screen data in a corresponding memory.

As shown in FIG. 2, according to a memory managing method according to the conventional technique having a construction described above, information about a storage memory included in the off-screen data is first checked (S10).

Herein, information about the storage memory is included in the off-screen data in advance when the user makes the off-screen data, and the device driver 10 can confirm the storage memory by checking the off-screen data.

As a result of the check, a memory for storing the off-screen data is confirmed, so that the off-screen data are stored in a corresponding memory (S11).

After that, the off-screen data to be outputted to the display part 40 are transferred to the video memory 30 and outputted.

However, the memory managing device and the method thereof have a problem in that a user incurs an inconvenience because of having to personally include information about a memory for storing the off-screen data in the off-screen data.

In the meantime, the greater the amount of off-screen data stored in the video memory 30 is, the better the performance of the display part 40 can be. For this reason, methods for transferring off-screen data stored in the main memory 20 to the video memory 30 when an empty space of the video memory 30 occurs have been suggested.

However, if the off-screen data are transferred to the video memory 20 without conditions, a load on the video memory 30 may increase, causing performance of the memory managing device to deteriorate.

That is, when separate processing is necessary for the off-screen data, it is more advantageous to store the off-screen data in the main memory 20 than in the video memory 30. However, the off-screen data are unconditionally stored in the video memory 30 even in the above case, thereby (being capable of) deteriorating the performance of a memory managing system.

### SUMMARY OF THE INVENTION

Accordingly, the present invention has been made to solve the above-mentioned problems occurring in the prior art, and an object of the present invention is to provide a dynamic memory managing device and a method thereof, which can improve users' convenience and performance of the device by automatically determining a memory for storing off-screen data such that the device maintains optimal performance by means of a predetermined variable value included the off-screen data.

In order to accomplish this object, there is provided a dynamic memory managing apparatus which determines a memory, in which off-screen data are stored, depending on a predetermined variable value, and stores the off-screen data in a corresponding memory as a result of a determination.

Preferably, the predetermined variable value includes the weight of each memory included in the off-screen data, a pointer for indicating the off-screen data in each memory, and a flag for representing a memory for storing the off-screen data.

Preferably, the weight of each memory is varied depending on a time required when performing a predetermined process for re-handling the off-screen data.

Advantageously, a memory for storing the off-screen data is determined by means of an operation value obtained through a predetermined operation using the weight of each memory.

Preferably, the variable value is initialized after the off-screen data are stored in a predetermined memory, and the variable value is set again according to a process for re-handling the off-screen data.

Preferably, it is determined whether or not the off-screen data are transferred to other memories by means of an operation value obtained through a predetermined operation using the re-set variable value.

Advantageously, the operation value is increased such that the off-screen data are stored in an already-stored memory, or the off-screen data are capable of being transferred if the operation value is out of a predetermined range, so that frequent transfer of the off-screen data to other memories is prevented.

Meanwhile, in order to accomplish this object, there is provided a dynamic memory managing method comprising the steps of: 1) determining an access state of off-screen data; and 2) determining a memory for storing the off-screen data by means of a predetermined variable value included in the off-screen data when an access of the off-screen data occurs.

Preferably, the predetermined variable value includes the weight of each memory included in the off-screen data, a pointer for indicating the off-screen data in each memory, and a flag for representing a memory for storing the off-screen data.

Preferably, the weight of each memory is varied depending on a time required when performing a predetermined process for re-handling the off-screen data.

Advantageously, in step 2), a memory for storing the off-screen data is determined by means of an operation value obtained through a predetermined operation using the weight of each memory.

Preferably, the dynamic memory managing method further comprises the steps of: 3) storing off-screen data in a memory determined depending on the operation value; and 4) resetting a variable value of the stored off-screen data.

Preferably, in step 3), the operation value is increased such that the off-screen data are stored in an already-stored memory, or the off-screen data are capable of being transferred if the operation value is out of a predetermined range, so that frequent transfer of the off-screen data to other memories is prevented.

Advantageously, the dynamic memory managing method further comprises a step of 5) initializing the variable value after the off-screen data are stored in a predetermined memory and resetting the variable value according to a process for re-handling the off-screen data.

Preferably, step 5) comprises a step of determining whether or not the off-screen data are transferred to other memories by means of an operation value obtained through a predetermined operation using the re-set variable value.

### BRIEF DESCRIPTION OF THE DRAWINGS

The above and other objects, features and advantages of the present invention will be more apparent from the following detailed description taken in conjunction with the accompanying drawings, in which:

FIG. 1 is a view showing a memory managing device in a conventional technique;

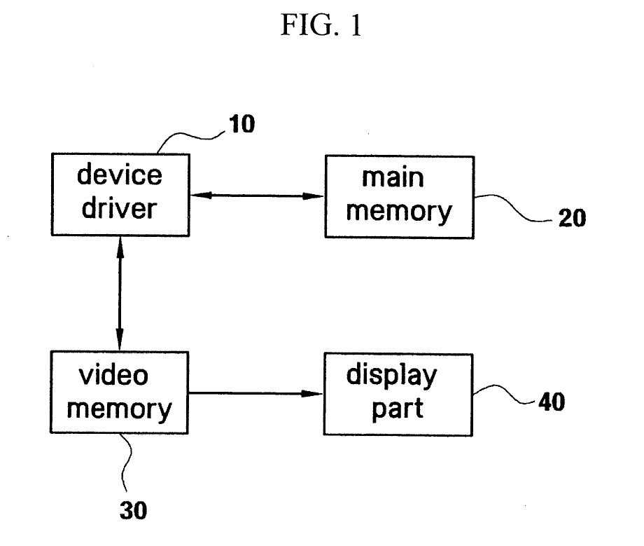

FIG. 2 is a flowchart showing a memory managing method in a conventional technique;

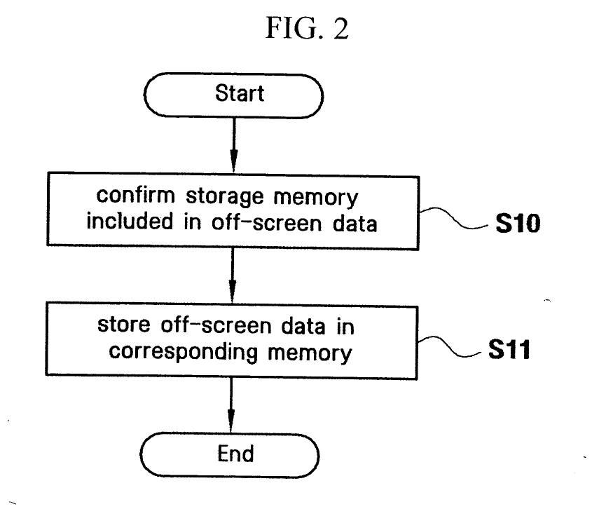

FIG. 3 is a view showing a dynamic memory managing device according to the present invention;

FIG. 4 is a flowchart showing a dynamic memory managing method according to the present invention; and

FIG. 5 is a view showing variable values included in off-screen data according to the present invention.

### DETAILED DESCRIPTION OF THE PREFERRED EMBODIMENTS

Hereinafter, embodiments of the present invention will be described in detail with reference to the accompanying drawings.

Advantages and features of the present invention, and methods for achieving them will be apparent to those skilled in the art from the detailed description of the embodiments together with the accompanying drawings. However, the scope of the present invention is not limited to the embodiments disclosed in the specification, and the present invention can be realized in various types. The described present embodiments are presented only for completely disclosing the present invention and helping those skilled in the art to completely understand the scope of the present invention, and the present invention is defined only by the scope of the claims. Additionally, the same reference numerals are used to designate the same elements throughout the specification and drawings.

Generally, a computer or a system embedded in a personal digital assistant (PDA), a cellular phone, a set-top box, etc., includes a central processing unit, a main memory unit, a secondary memory unit, an input unit, an output unit, etc.

As the demand for various multimedia functions increases, the output unit has been developed as a form suitable for processing of a large amount of data.

The performance of the output unit is dependent on the performance of a video memory for storing data to be outputted to the output unit, which are off-screen data.

Accordingly, the greater the amount of the off-screen data which will be outputted through the output unit and stored in the video memory is, the better the performance of the output unit may be.

Herein, if all off-screen data are stored in the video-memory, the load on the video memory increases, so that performance of the output unit may be lowered. For this reason, the off-screen data are selectively stored in other memories, such as the main memory, as well as the video memory, so that it is possible to prevent the load on the video memory from increasing.

Also, if a space for storing the off-screen data resides in the video memory, the off-screen data stored in the main memory are transferred to the video memory. Therefore, performance of the output unit can be improved.

However, if processes for re-handling the off-screen data, such as a redrawing process, are required, it is advantageous that the off-screen data are stored in the main memory rather than the video memory.

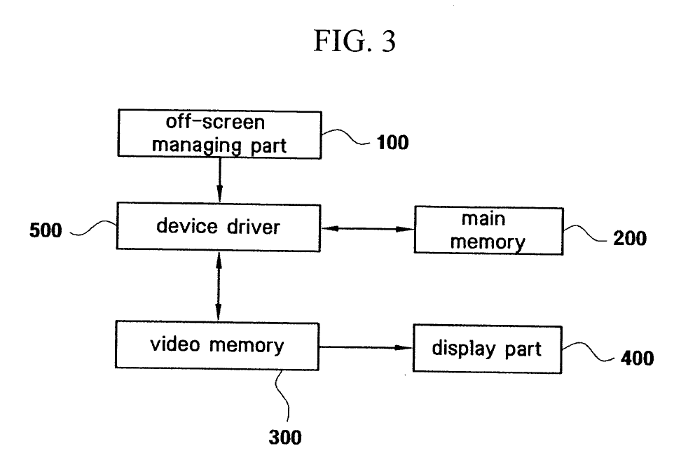

FIG. 3 shows a dynamic memory managing device according to one embodiment of the present invention.

As shown in FIG. 3, the dynamic memory managing device includes an off-screen managing part 100 for determining a memory for storing the off-screen data by means of a predetermined variable value included in the off-screen data, a main memory 200 and a video memory 300 for storing the off-screen data, a display part 400 for outputting off-screen data stored in the video memory 300, and a device driver 500 for performing an overall function relating to storing off-screen data in the main memory 200 and the video memory 300.

Herein, the variable value included in the off-screen data includes the weight of each memory storing the off-screen data.

That is, speaking of an example in which a memory storing the off-screen data is the main memory 200 or the video memory 300, the variable value may include a weight for the main memory 200 and the video memory 300.

Such a weight for each memory can be determined by a user having made the off-screen data, or through processes handling the off-screen data.

Herein, the processes handling the off-screen data include a process immediately outputting the off-screen data, a process additionally re-handling the off-screen data, etc.

Meanwhile, the weight of each memory is included in the off-screen data as a score, and a memory for storing the off-screen data is determined by means of an operation value obtained after performing a predetermined operation for the weight of each memory.

That is, speaking of an example in which a memory storing the off-screen data is the main memory 200 or the video memory 300, if the difference between the weight of the main memory 200 and the weight of the video memory 300 is positive, the off-screen data may be stored in the main memory 200. Otherwise, the off-screen data may be stored in the video memory 300.

Herein, a memory for storing the off-screen data and an operation for determining the memory can be changed as occasion demands.

In the meantime, after storing the off-screen data according to a predetermined operation, a variable value included in the off-screen data is initialized. Then, the variable value of the stored off-screen data is re-determined through processes handling the off-screen data.

Accordingly, if a memory for optimizing the performance of the output unit through an operation using the variable value is changed, the off-screen data are transferred to and stored in a corresponding memory.

At this time, if an operation value using the weight of each memory is frequently changed, that is, if the off-screen data are frequently transferred between the main memory 200 and the video memory 300, performance of the output unit may be lowered.

Accordingly, if the off-screen data are stored in a predetermined memory, the operation value is increased by a predetermined value such that the off-screen data are stored in a memory, in which the off-screen data have been already stored. Thus, it is possible to prevent the off-screen data from frequently being transferred.

Also, once the off-screen data are stored in the predetermined memory, the off-screen data are not transferred into another memory until the operation value is out of a predetermined range. Thus, it is possible to prevent the off-screen data from frequently being transferred.

Hereinafter, a dynamic memory managing method according to the present invention having a construction described above will be described.

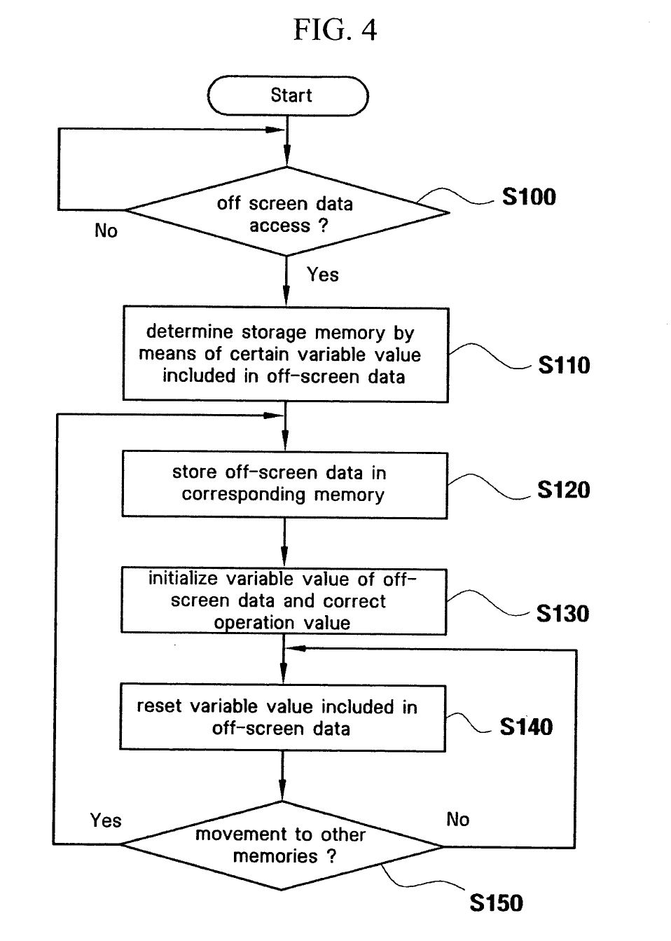

As shown in FIG. 4, in the dynamic memory managing method according to the present invention, an access state of the off-screen data is firstly checked (S100).

At this time, the access state of the off-screen data can be determined by an interpreter system for parsing source codes made by a user or intermediate codes capable of being changed into the source codes.

Accordingly, if the off-screen data are created through a user's application or a user's graphic library, the interpreter system analyzes codes of the off-screen data so as to determine whether or not the current access data are off-screen data.

As a result of the determination, if the current access data are off-screen data, the off-screen data are firstly stored in the main memory 200, and then, the off-screen managing part 100 determines a memory for storing the off-screen data through an operation using a predetermined variable value included in the off-screen data (S110).

At this time, the off-screen managing part 100 determines a memory for storing the off-screen data by means of an operation value obtained by performing a predetermined operation using the variable value which is the weight of each memory.

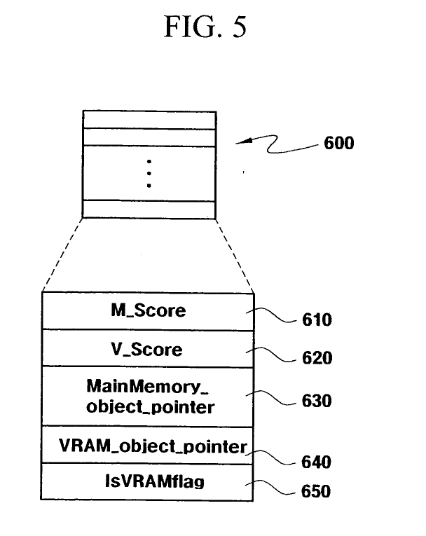

As shown in FIG. 5, speaking of an example in which the off-screen data are stored in the main memory 200 or the video memory 300, the variable value of off-screen data 600 includes “M_Score” 600 which is the weight for the main memory 200, “V_Score” 620 which is the weight for the video memory 300, “MainMemory_object_pointer” 630 and “VRAM_object_pointer” 640 which are pointers for the off-screen data on the main memory 200 and the video memory 300, and “IsVRAMflag” 650 which is a flag representing a memory for storing the off-screen data.

Herein, “M_score” 610 which is the weight of the main memory 200 and “V_score” 620 which is the weight of the video memory 300 can determine a memory for storing the off-screen data according to an operation value obtained after a predetermined operation is performed.

Hereinafter, an example in which a memory for storing the off-screen data is determined according to a range including the operation value on the basis of a predetermined upper limit value and a predetermined lower limit value of the operation value will be described according to one embodiment of the present invention.

In detail, if the operation value is less than the lower limit value, the off-screen data are stored in the main memory 200. If the operation value exceeds the upper limit value, the off-screen data are stored in the video memory 300. If the operation value is within the range of the upper limit value and the lower limit value, a process for re-updating a node sequence of the off-screen data according to the operation value is performed.

The upper limit value and the lower limit value can be set according to the size of the video memory 300, a data access rate for a reading/writing operation with respect to the main memory 200, a data access rate for a reading/writing operation with respect to the video memory 300, a data transferring rate from the main memory 200 to the video memory 300, and a data transferring rate from the video memory 300 to the main memory 200.

In detail, if the off-screen data are transferred between the main memory 200 and the video memory 300 at the same data transferring rate, the upper limit value is set identical to the lower limit value. If a data transferring rate from the main memory 200 to the video memory 300 is faster than a data transferring rate from the video memory 300 to the main memory 200, the upper limit value can be set smaller than the lower limit value.

Also, if the size of the video memory 300 is small, the upper limit value can be set as a large value in order to prevent the off-screen data from transferring to the video memory 300.

In addition, if an access rate for a reading and writing operation with respect to the main memory 200 is faster than that of the video memory 300, the lower limit value can be set to a small value. If an access rate for a reading and writing operation with respect to the video memory 300 is faster than that of the main memory 200, the upper limit value can be set to a small value.

If the off-screen data are stored in a predetermined memory according to the operation value (S120), a variable value included in the off-screen data is initialized. Then, a correction is performed, in which the operation value is increased by a predetermined value such that the off-screen data can be stored in the predetermined memory. Therefore, it is possible to prevent the off-screen data from frequently being transferred to other memories (S130).

Also, together with the correction of increasing the operation value, it is possible to prevent the off-screen data from frequently being transferred to other memories by allowing the off-screen data to be transferred to other memories if the operation value is out of the predetermined range.

After initializing the variable value of the off-screen data, the variable value is re-set again (S140).

This is because the off-screen data can be transferred to other memories in order to optimize performance of the output unit even though the off-screen data are stored in the predetermined memory,

Herein, since frequent transfer of data to other memories is prevented through the correction of the operation value, it is possible to prevent a lowering of the performance caused by frequent transfer of data to other memories.

The re-set variable value determines whether or not the off-screen data are transferred to other memories according to an operation value obtained after a predetermined operation is performed (S150). If the off-screen data are transferred to other memories, the variable value of the off-screen data is initialized, and then, steps 120 to 140 for determining data transfer to other memories are repeatedly performed.

As described above, according to the present invention, a memory for storing the off-screen data is automatically determined by means of an operation value obtained after performing a predetermined operation using a variable including the weight of each memory included in the off-screen data, thereby resolving vexatiousness that a user personally determines a memory for storing the off-screen data. Therefore, it is possible to improve the users' convenience.

Also, the off-screen data can be transferred to other memories by means of a variable value included in the off-screen data after the off-screen data are stored in a predetermined memory. Therefore, it is possible to improve the performance of a system.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A dynamic memory managing apparatus comprising:
a determining device that determines which memory into which off-screen data are to be stored, wherein the determination depends on a predetermined variable value; and
a storing device that stores the off-screen data in a corresponding memory based on a result of the determination.

2. The dynamic memory managing apparatus as claimed in claim 1, wherein the predetermined variable value includes, a weight corresponding to each memory included in the off-screen data, a pointer for indicating the off-screen data in each memory, and a flag for representing a memory for storing the off-screen data.

3. The dynamic memory managing apparatus as claimed in claim 2, wherein the weight of each memory is varied depending on a time required for performing a predetermined process for re-handling the off-screen data.

4. The dynamic memory managing apparatus as claimed in claim 3, wherein the memory for storing the off-screen data is determined by an operation value obtained through a predetermined operation using the weight of each memory.

5. The dynamic memory managing apparatus as claimed in claim 4, wherein the variable value is initialized after the off-screen data are stored in a predetermined memory, and the variable value is reset according to a process for re-handling the off-screen data.

6. The dynamic memory managing apparatus as claimed in claim 5, wherein it is determined whether or not the off-screen data are transferred to other memories by means of an operation value obtained through a predetermined operation using the reset variable value.

7. The dynamic memory managing apparatus as claimed in claim 6, wherein the operation value is increased such that the off-screen data are stored in a memory into which data has already been stored, or the off-screen data are capable of being transferred if the operation value is out of a predetermined range, so that frequent transfer of the off-screen data to the other memories is prevented.

8. A dynamic memory managing method comprising:
1) determining an access state of off-screen data; and
2) determining a memory for storing the off-screen data by means of a predetermined variable value included in the off-screen data when an access of the off-screen data occurs.

9. The dynamic memory managing method as claimed in claim 8, wherein the predetermined variable value includes a weight corresponding to each memory included in the off-screen data, a pointer for indicating the off-screen data in each memory, and a flag for representing a memory for storing the off-screen data.

10. The dynamic memory managing method as claimed in claim 9, wherein the weight of each memory is varied depending on a time required for performing a predetermined process for re-handling the off-screen data.

11. The dynamic memory managing method as claimed in claim 10, wherein, in step 2), a memory for storing the off-screen data is determined by means of an operation value obtained through a predetermined operation using the weight of each memory.

12. The dynamic memory managing method as claimed in claim 11, further comprising:
3) storing off-screen data in a memory that is determined depending on the operation value; and
4) resetting a variable value of the stored off-screen data.

13. The dynamic memory managing method as claimed in claim 12, wherein, in step 3), the operation value is increased such that the off-screen data are stored in a memory that has already had data stored therein, or the off-screen data are capable of being transferred if the operation value is out of a predetermined range, so that frequent transfer of the off-screen data to other memories is prevented.

14. The dynamic memory managing method as claimed in claim 8, further comprising, 5) initializing the variable value after the off-screen data are stored in a predetermined memory and resetting the variable value according to a process for re-handling the off-screen data.

15. The dynamic memory managing method as claimed in claim 14, wherein step 5) comprises determining whether or not the off-screen data are transferred to other memories by means of an operation value obtained through a predetermined operation using the reset variable value.
